(19) United States
(12) Patent Application Publication
(10) Pub. No.: US 2014/0310218 A1
(43) Pub. Date: Oct. 16, 2014

(54) High-Order Semi-RBMs and Deep Gated Neural Networks for Feature Interaction Identification and Non-Linear Semantic Indexing

(71) Applicant: NEC LABORATORIES AMERICA, INC., PRINCETON, NJ (US)

(72) Inventors: Renqiang Min, Plainsboro, NJ (US); Bing Bai, Princeton Junction, NJ (US)

(73) Assignee: NEC LABORATORIES AMERICA, INC., PRINCETON, NJ (US)

(21) Appl. No.: 14/243,311

(22) Filed: Apr. 2, 2014

Related U.S. Application Data
(60) Provisional application No. 61/810,812, filed on Apr. 11, 2013.

(51) Int. Cl. G06N 3/08

(52) U.S. Cl. CPC G06N 3/08
USPC 706/16

(57) ABSTRACT

Systems and method are disclosed for determining complex interactions among system inputs by using semi-Restricted Boltzmann Machines (RBMs) with factorized gated interactions of different orders to model complex interactions among system inputs; applying semi-RBMs to train a deep neural network with high-order within-layer interactions for learning a distance metric and a feature mapping; and tuning the deep neural network by minimizing margin violations between positive query document pairs and corresponding negative pairs.

The present application claims priority to Provisional Application Ser. No. 61/810,812 filed on Apr. 11 2013, the content of which is incorporated by reference.

### BACKGROUND

A major challenge in information retrieval and computational system biology is to study how complex interactions among system inputs influence final system outputs. In information retrieval, we often need to find the most relevant documents or webpages or product descriptions to a query in a lot of scenarios such as online search, and modeling deep semantically complex interactions among words and phrases is very important. For example, “bark” interacting with “dog” means something different than “bark” interacting with “tree”. In computational biology, high-throughput genome-wide molecular assays simultaneously measure the expression level of thousands of genes, which probe cellular networks from different perspectives. These measurements provide a “snapshot” of transcription levels within the cell. As one of the most recent techniques, Chromatin InmmunoPrecipitation followed by parallel sequencing (ChIP-Seq) makes it possible to accurately identify Transcription Factor (TF) bindings and histone modifications at a genome-wide scale. These data enable us to study the combinatorial interactions involving TF bindings and histone modifications. Or another example in computational biology, proteins normally carry out their functions by grouping or binding with other proteins. Modeling high-order protein interaction groups that only appear in disease samples but not in normal samples for accurate disease status prediction such as cancer diagnosis is still a very challenging problem.

In information retrieval, our previous approach called Supervised Semantic Indexing (SSI) based on linear transformation and polynomial expansions has been used for document retrieval, but it doesn't consider complex high-order interactions among words and it has a shallow model architecture with limited learning capabilities. In computational biology, previous attempts focus on genome-wide pairwise co-association analysis using simple correlations, clustering, or Bayesian Networks. These approaches either do not reveal higher-order dependencies between input variables (genes) such as how the activity of one gene can affect the relationship between two or more other genes, or impose non-existing cause-effect relationships among genes.

### SUMMARY

We disclose systems and methods for determining complex interactions among system inputs by using semi-Restricted Boltzmann Machines (RBMs) with factorized gated interactions of different orders to model complex interactions among system inputs; applying semi-RBMs to train a deep neural network with high-order within-layer interactions for learning a distance metric and a feature mapping; and tuning the deep neural network by minimizing margin violations between positive query document pairs and corresponding negative pairs.

Implementations of the above aspect can include one or more of the following. Probabilistic graphical models are widely used for extracting insightful semantic or biological mechanistic information from input data and often provide a concise representation of complex system input interactions. A new framework can be used for discovering interactions among words and phrases based on discretized TF-IDF representation of documents and among Transcription Factors (TFs) based on multiple ChIP-Seq measurements. We extend Restricted Boltzmann Machine (RBM) to discover input feature interactions of arbitrary order. Instead of just focusing on modeling image mean and covariance as in mean-covariance RBM, our semi-RBMs here have gated interactions with a combination of orders ranging from 1 to m to approximate the arbitrary-order combinatorial input feature interactions in words and in TFs. The hidden units of our semi-RBMs act as binary switches controlling the interactions between input features. We use factorization to reduce the number of parameters. The semi-RBM with gated interaction of order 1 exactly corresponds to the traditional RBM. The discrete nature of our input data enables us to get samples from our semi-RBMs by using either fast deterministic damped mean-field updates or prolonged Gibbs sampling. The parameters of semi-RBMs are learned using Contrastive Divergence. After a semi-RBM is learned, we can treat the inferred hidden activities of input data as new data to learn another semi-RBM. This way, we can form a deep belief net with gated high-order interactions. Given pairs of discrete representations of a query and a document, we use these semi-RBMs with gated arbitrary-order interactions to pre-train a deep neural network generating a similarity score between the query and the document, in which the penultimate layer corresponds to a very powerful non-linear feature embedding of the original system input features. Then we use back-propagation to fine-tune the parameters of this deep gated high-order neural network to make positive pairs of query and document always have larger similarity scores than negative pairs based on margin maximization.

The system uses semi-RBMs with factorized gated interactions of a combination of different orders to model complex interactions among system inputs, with applications in modeling the complex interactions between different words in documents and queries and predicting the bindings of some TFs given some other TFs, which provides us with some insight into understanding deep semantic information for information retrieval and TF binding redundancy and TF interactions for gene regulation.

The semi-RBMs are used to efficiently train a deep neural network with high-order within-layer interactions, which is one of the first deep neural networks capable of dealing with high-order lateral connections for learning a distance metric and a feature mapping.

The deep neural network is fine-tuned by minimizing margin violations between positive query-document pairs and corresponding negative pairs, which is one of the first attempts of combining large-margin learning and deep gated neural networks.

Advantages of the system may include one or more of the following. The system extends Restricted Boltzmann Machine (RBM) to discover input feature interactions of arbitrary order. The system is capable of capturing combinatorial interactions between system inputs. In addition to modeling real continuous image data, the system can handle discrete data. Instead of just focusing on modeling image mean and covariance as in mean-covariance RBM, our semi-RBMs here have gated interactions with a combination of orders ranging from 1 to m to approximate the arbitrary-order combinatorial input feature interactions in words and in TFs. The system can be used to identify complex non-linear system input interactions for data de-noising and data visualization, especially in biomedical applications and scientific data explorations. The system can also be used to improve the performance of current search engines, collaborative filtering systems, online advertisement recommendation systems, and many of other e-commerce systems.

### BRIEF DESCRIPTION OF THE DRAWINGS

FIG. 1 shows an exemplary deep neural network with gated high order interactions.

FIG. 2 shows in more details our process for forming and training a deep neural network.

FIG. 3 shows a system for High-Order Semi-Restricted Boltzmann Machines for Feature Interaction Identification and Non-linear Semantic Indexing.

FIG. 4 shows an exemplary computer for running a High-Order Semi-Restricted Boltzmann Machines for Feature Interaction Identification and Non-linear Semantic Indexing.

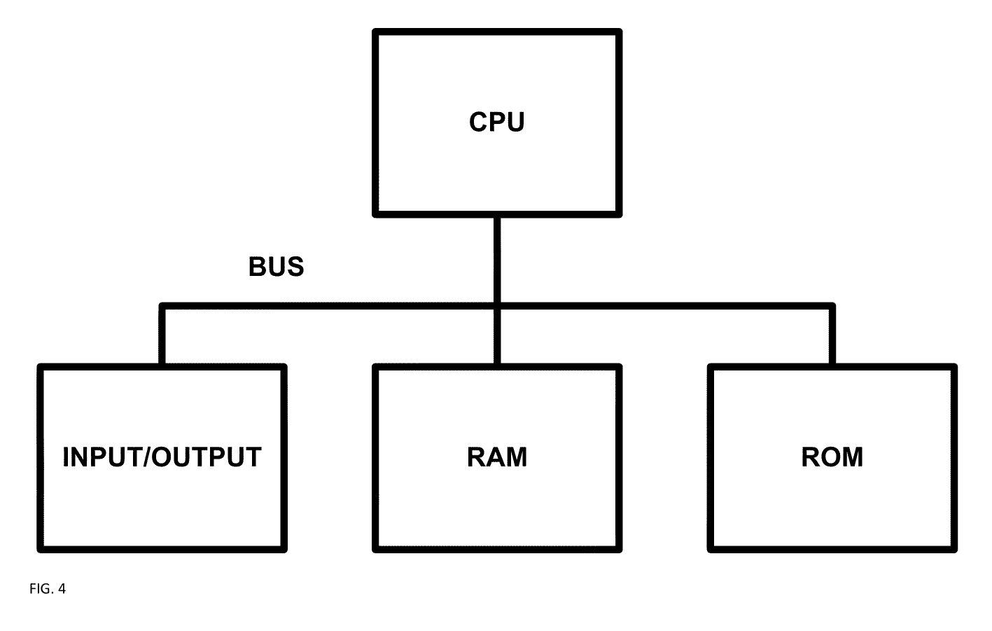

### DESCRIPTION

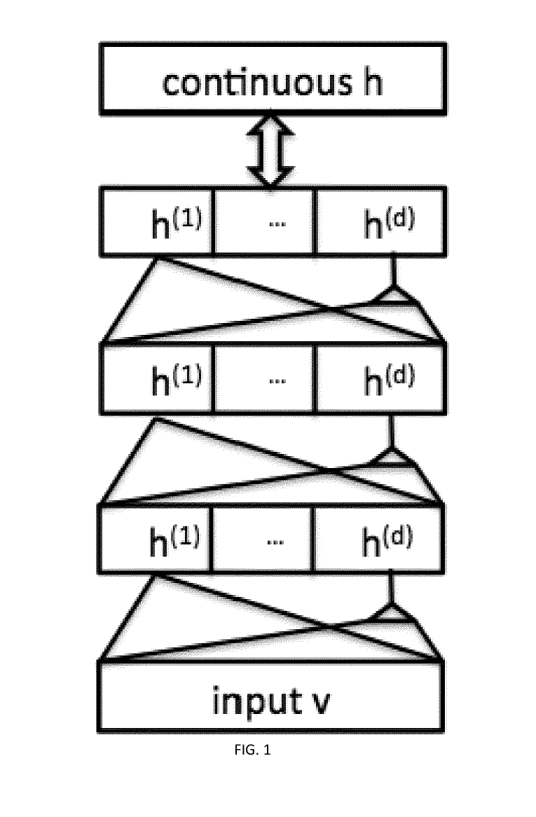

FIG. 1 shows an exemplary deep neural network with gated high order interactions. In FIG. 1, the top-layer weights are pre-trained with a traditional Restricted Boltzmann Machine (RBM), and the weights connecting other layers are pre-trained with high-order semi-RBMs. The probabilistic graphical models are used for extracting insightful semantic or biological mechanistic information from input data and often provide a concise representation of complex system input interactions. The highest order d in different hidden layers do not need to take the same value and they can be different. We use the same symbol d in different layers in the figure just for illustration convenience.

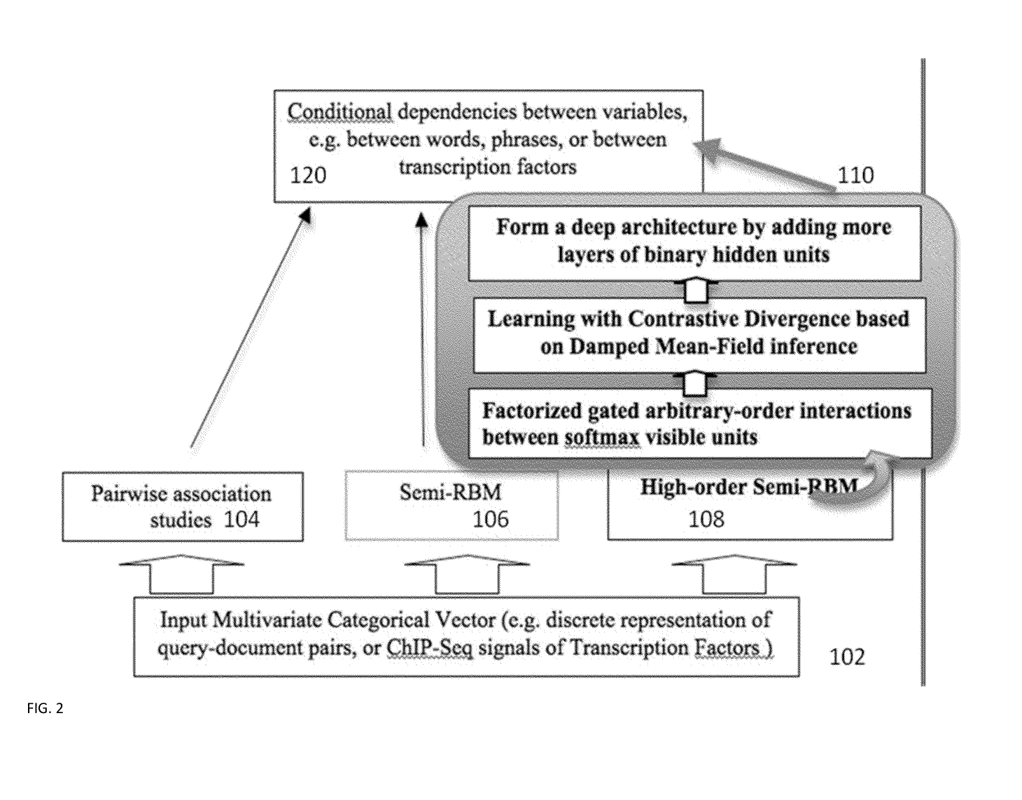

FIG. 2 shows in more details our process for forming and training a deep neural network. The process receives as input multi-variate categorical vectors such as discrete representation of query-document pairs or transcription factor signals, for example (102). With the input data, the process performs a pairwise association study (104) and sets-up one or more semi-RBMs (106). In addition, the process sets up one or more high order semi-RBMs (108). Non-linear Supervised Semantic Indexing based on Deep Neural Networks with Gated High-Order Interactions is done (110). In operation 110, the process additionally determines factorized gated arbitrary orders interactions between softmax visible units; and the process then learns with contrastive divergence based on damped mean-field interference, and forms a deep architecture by adding more layers of binary hidden units. In 120, the outputs from 104, 106 and 110 are used to generate conditional dependencies among variables such as those between words, phrases, or between transcription factors, for example.

The framework of FIG. 2 can be used for discovering interactions among words and phrases based on discretized TF-IDF representation of documents and among Transcription Factors (TFs) based on multiple ChIP-Seq measurements. The RBMs are used to discover input feature interactions of arbitrary order. Instead of just focusing on modeling image mean and covariance as in mean-covariance RBM, our semi-RBMs here have gated interactions with a combination of orders ranging from 1 to m to approximate the arbitrary-order combinatorial input feature interactions in words and in TFs. The hidden units of our semi-RBMs act as binary switches controlling the interactions between input features. We use factorization to reduce the number of parameters. The semi-RBM with gated interaction of order 1 exactly corresponds to the traditional RBM. The discrete nature of our input data enables us to get samples from our semi-RBMs by using either fast deterministic damped mean-field updates or prolonged Gibbs sampling. The parameters of semi-RBMs are learned using Contrastive Divergence. After a semi-RBM is learned, we can treat the inferred hidden activities of input data as new data to learn another semi-RBM. This way, we can form a deep belief net with gated high-order interactions. Given pairs of discrete representations of a query and a document, we use these semi-RBMs with gated arbitrary-order interactions to pre-train a deep neural network generating a similarity score between the query and the document, in which the penultimate layer corresponds to a very powerful non-linear feature embedding of the original system input features. Then we use back-propagation to fine-tune the parameters of this deep gated high-order neural network to make positive pairs of query and document always have larger similarity scores than negative pairs based on margin maximization.

The system uses semi-RBMs with factorized gated interactions of a combination of different orders to model complex interactions among system inputs, with applications in modeling the complex interactions between different words in documents and queries and predicting the bindings of some TFs given some other TFs, which provides us with some insight into understanding deep semantic information for information retrieval and TF binding redundancy and TF interactions for gene regulation.

The semi-RBMs are used to efficiently train a deep neural network with high-order within-layer interactions, which is one of the first deep neural networks capable of dealing with high-order lateral connections for learning a distance metric and a feature mapping. The deep neural network is fine-tuned by minimizing margin violations between positive query-document pairs and corresponding negative pairs, which is one of the first attempts of combining large-margin learning and deep gated neural networks.

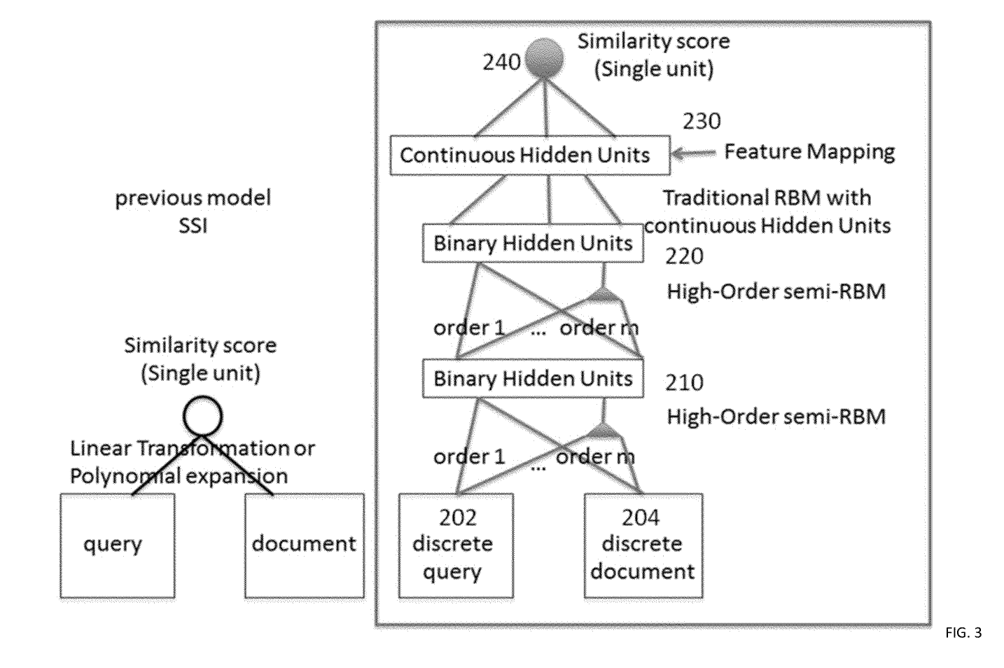

FIG. 3 shows a system for High-Order Semi-Restricted Boltzmann Machines for Feature Interaction Identification and Non-linear Semantic Indexing. The system receives discrete query from module 202 and discrete documents 204. The data from 202 and 204 are provided to a high order semi-RBM of order m with binary hidden units 210. The outputs of binary hidden units 210 are provided another high order semi-RBM of order m with binary hidden units 220 (m can be 1). The outputs of binary hidden units 220 are provided to feature mapping unit 230 which is an RBM with continuous hidden units, and the result is summed by a similarity score unit 240.

As in traditional SSI, a training is conducted by minimizing the following margin ranking loss on a tuple (q, d⁺, d⁻):

$${\sum }_{( q , {d}^{+} , {d}^{-} )} max ( 0 , 1 - f ( q , {d}^{+} ) + f ( q , {d}^{-} ) ) ,$$

where q is the query, d⁺ is a relevant document, and d⁻ is an irrelevant document, f(·,·) is the similarity score.

Next, we will discuss implementations of the RBM system. RBM is an undirected graphical model with one visible layer v and one hidden layer h. There are symmetric connections W between the hidden layer and the visible layer, but there are no within-layer connections. For a RBM with stochastic binary visible units v and stochastic binary hidden units h, the joint probability distribution of a configuration (v, h) of RBM is defined based on its energy as follows:

$$\begin{matrix}- E ( v , h ) = {\sum }_{ij} {W}_{ij} {v}_{i} {h}_{j} + {\sum }_{i} {b}_{i} {v}_{i} + {\sum }_{j} {c}_{j} {h}_{j} & ( 1 ) \\ p ( v , h ) = \frac{1}{Z} exp ( - E ( v , h ) ) , & ( 2 )\end{matrix}$$

where b and c are biases, and Z is the partition function with Z=Σ_{u,g}exp(−E(u,g)). Due to the bipart structure of RBM, given the visible states, each hidden unit is conditionally independent, and given the hidden states, the visible units are conditionally independent.

$$\begin{matrix}p ( {v}_{i} = 1 \vert h ) = sigmoid ( {\sum }_{j} {W}_{ij} {h}_{j} + {b}_{i} ) , & ( 3 ) \\ p ( {h}_{j} = 1 \vert v ) = sigmoid ( {\sum }_{i} {W}_{ij} {v}_{i} + {c}_{j} ) , \\ where sigmoid ( z ) = \frac{1}{1 + exp ( - z )} . & ( 4 )\end{matrix}$$

This nice property allows us to get unbiased samples from the posterior distribution of the hidden units given an input data vector. By minimizing the negative log-likelihood of the observed input data vectors using gradient descent, the update rule for the weight W is as follows,

ΔWᵢⱼ=ε(<vᵢhⱼ>_{data}−<vᵢhⱼ>_{∞}). (5)

where ε is learning rate, <·>_{data} denotes the expectation with respect to the data distribution and <·>_{∞} denotes the expectation with respect to the model distribution. In practice, we do not have to sample from the equilibrium distribution of the model, and even one-step reconstruction samples work very well [?].

ΔWᵢⱼ=ε(<vᵢhⱼ>_{data}−<vᵢhⱼ>_{recon}), (6)

Although the above update rule does not follow the gradient of the log-likelihood of data exactly, it works very well in practice. In [?], it is shown that a deep belief net based on stacked RBMs can be trained greedily layer by layer. Given some observed input data, we train a RBM to get the hidden representations of the data. We can view the learned hidden representations as new data and train another RBM. We can repeat this procedure many times to pretrain a deep neural network, and then we can use backpropagation to fine-tune all the network connection weights.

In RBM, the marginal distribution of visible units is as follows,

$$p ( v ) ∝ exp ( {\sum }_{i} {b}_{i} {v}_{i} ) {Π}_{j} ( 1 + exp ( {\sum }_{i} {w}_{ij} {v}_{i} + {c}_{j} ) ) .$$

The above distribution shows that RBM can be viewed as a model of Product of Experts (PoE), in which each hidden unit corresponds to a mixture expert, and the non-linear dependency between visible units are implicitly encoded owing to the non-factorization property of each expert.

Next we discuss the use of Semi-Restricted Boltzmann Machine for discrete categorical data. RBM without lateral connections captures dependencies between visible units (features) in a less convenient way, which involves much more coordinations than semi-RBMs. In the following, we will describe two different types of semi-RBMs tailored for modeling feature dependencies in discrete categorical data.

We extend the energy function of RBM in Equation 1 to handle both discrete categorical data and feature dependencies by explict lateral connections and we call the resulting model “lateral semi-RBM” (IsRBM). The energy function of IsRBM is,

$$- E ( v , h ) = {\sum }_{ijk} {W}_{ij}^{k} {v}_{i}^{k} {h}_{j} + {\sum }_{ik} {b}_{i}^{k} {v}_{i}^{k} + {\sum }_{j} {c}_{j} {h}_{j} - {\sum }_{i} log {Z}_{i} + {\sum }_{{ii}^{′} {kk}^{′} : i < {i}^{′}} {L}_{{ii}^{′} {kk}^{′}} {v}_{i}^{k} {v}_{{i}^{′}}^{{k}^{′}} , \qquad ( 7 )$$

where we use K softmax binary visible units to represent each discrete feature taking values from 1 to K, vᵢ^{k}=1 if and only if the discrete value of the i-th feature is k, Wᵢⱼ^{k} is the connection weight between the k-th softmax binary unit of feature i and hidden unit j, Zᵢ is the normalization term enforcing that the probabilities of feature i's taking all possible discrete values, that is, the marginal probabilities {p(vᵢ^{k}=1|h, v)}ₖ, sum to 1, and L_{ii′ kk′} is the lateral connection weight between feature i taking value k and feature i taking value k′ (except explicitly mentioned, in all subsequent descriptions, we will use i for indexing visible units, j for indexing hidden units, and Z for denoting normalization terms). If we have n features and K possible discrete values for each feature, we have

$$\frac{n ( n - 1 ) {K}^{2}}{2}$$

lateral connection weights. The lateral connections between visible units do not affect the conditional distributions for hidden units p(hⱼ|v), which are still conditionally independent as in RBM, but the conditional distributions p(vᵢ^{k}|h) are not independent anymore. We use “damped mean-field” updates to get approximate samples {r(vᵢ^{k})} from p(v|h). Then we have,

$$\begin{matrix} p ( {h}_{j} = 1 \vert v ) = sigmoid ( {\sum }_{ik} {W}_{ij}^{k} {v}_{i}^{k} + {c}_{j} ) & ( 8 ) \\ {r}^{0} ( {v}_{i}^{k} ) = soft max ( {\sum }_{j} {W}_{ij}^{k} {h}_{j} + {b}_{i}^{k} , k ) & ( 9 ) \\ {r}^{t} ( {v}_{i}^{k} ) = λ {r}^{t - 1} ( {v}_{i}^{k} ) + ( 1 - λ ) \times soft max ( {\sum }_{j} {W}_{ij}^{k} {h}_{j} + {\sum }_{{i}^{′} {k}^{′} : {i}^{′} \neq i} {L}_{{ii}^{′} {kk}^{′}} {r}^{t - 1} ( {v}_{{i}^{′}}^{{k}^{′}} ) + {b}_{i}^{k} , k ) \\ t = 1 , … , T , 0 < λ < 1 , \\ where soft max ( {z}_{k} , k ) = \frac{exp ( {z}_{k} )}{{\sum }_{k = 1}^{K} exp ( {z}_{k} )} , & ( 10 )\end{matrix}$$

T is the maximum number of iterations of mean-field updates, and, instead of using p(vᵢ^{k}=1|h) from RBM to initialize {r⁰(vᵢ^{k})}, we can also use a data vector v for initialization here.

As in RBM, we use contrastive divergence to update the connection weights of IsRBM to approximately maximize the log-likelihood of observed data.

ΔWᵢⱼ^{k}=ε(<vᵢ^{k}hⱼ>_{data}−<vᵢ^{k}hⱼ>_{recon}),

ΔL_{ii′}^{kk′}=ε(<Vᵢ^{k}v_{i′}^{k″}>_{data}−<r^{T}(vᵢ^{k})r^{T}(r_{i′}^{k′})>_{recon}),

Δbᵢ^{k}=ε(<vᵢ^{k}>_{data}−<r^{T}(vᵢ^{k})>_{recon}),

Δcⱼ=ε(<hⱼ>_{data}−<hⱼ>_{recon}),

where we also use a small number of steps of sampled reconstructions to approximate the terms under model distribution.

In IsRBM, the marginal distribution p(v) takes the following form,

$$p ( v ) ∝ exp ( {\sum }_{ik} {b}_{i}^{k} {v}_{i}^{k} + {\sum }_{{ii}^{′} {kk}^{′} : i < {i}^{′}} {L}_{{ii}^{′} {kk}^{′}} {v}_{i}^{k} {v}_{{i}^{′}}^{{k}^{′}} ) \\ {Π}_{j} ( 1 + exp ( {\sum }_{ik} {w}_{ij}^{k} {v}_{i}^{k} + {c}_{j} ) ) , \qquad ( 12 )$$

where vᵢ^{k}=1 if and only if the discrete value of feature i is k. This marginal distribution shows that the dependencies between pairwise features are only captured by the explicit lateral connection weights L_{ii′} as biase terms. As in RBM, the hidden units of IsRBM also play the role of defining mixture experts, and the higher-order dependencies between features are implictly captured by the product of the mixture experts.

Next we will consider Semi-RBM with factored multiplicative interaction terms. One exemplary semi-RBM that uses hidden units to directly modulate the interactions between features can be defined with the following energy function (we omit biase terms here for description convenience),

$$- E ( v , h ) = {\sum }_{{ii}^{′} j} {W}_{{ii}^{′} j} {v}_{i} {v}_{{i}^{′}} {h}_{j} . \qquad ( 13 )$$

However, in this energy function, we need mn² parameters provided that we have n visible units and m hidden units. Factorization is used to approximate the three-way interaction weight W_{ii′j} by Σ_{f}W_{if}W_{i′f}U_{jf}. In this way, the above energy function with three-way interactions can be written as Σ_{f}(ΣᵢW_{if}vᵢ)²(ΣⱼU_{jf}hⱼ). In the following, we extend factored semi-RBMs for modeling discrete categorical data with an arbitrary order of feature interactions. Using K softmax binary units to represent a dicrete feature with K possible values as in the previous section, the energy function of factored semi-RBM for discrete data is,

$$- E ( v , h ) = {\sum }_{f} {( {\sum }_{ik} {W}_{if}^{k} {v}_{i}^{k} )}^{d} ( {\sum }_{j} {U}_{jf} {h}_{j} ) - {\sum }_{i} log {Z}_{i}^{′} + {\sum }_{ik} {b}_{i}^{k} {v}_{i}^{k} + {\sum }_{j} {c}_{j} {h}_{j} , \qquad ( 14 )$$

where d is a user-defined parameter that controls the order of interactions between features. If d=2, the above energy function will capture all possible pairwise feature interactions, which is a factored version of Equation 13. We call the semi-RBM defined by the energy function “factored semi-RBM” (fsRBM). In fsRBM, the marginal distribution of visible units is,

$$p ( v ) ∝ exp ( {\sum }_{ik} {b}_{i}^{k} {v}_{i}^{k} ) \times {Π}_{j} ( 1 + exp ( {\sum }_{f} {( {\sum }_{ik} {W}_{if}^{k} {v}_{i}^{k} )}^{d} {U}_{jf} + {c}_{j} ) ) . \qquad ( 15 )$$

The marginal distribution of fsRBM can also be viewed as a PoE model, and each expert is a mixture model. However, unlike in IsRBM, each hidden unit can be used to choose a mixture component modeling d-th order interactions between features, thereby modulating high-order interactions between features directly. As in IsRBM, complex non-linear dependencies between features are also implictly encoded by the PoE model.

In the above fsRBM, only d-th order interactions are explictly considered in the energy function, and now we extend it to include all the interactions with all possibler orders smaller than or equal to d, and we call the resulting model “factored polynomial semi-RBM” (fpsRBM). The energy function of fpsRBM is,

$$- E ( v , h ) = {\sum }_{f} {\sum }_{a = 1}^{d} {( {\sum }_{ik} {W}_{if}^{( a ) k} {v}_{i}^{k} )}^{a} ( {\sum }_{j} {U}_{jf}^{( a )} {h}_{j}^{( a )} ) - {\sum }_{i} log {Z}_{i}^{″} + {\sum }_{ik} {b}_{i}^{k} {v}_{i}^{k} + {\sum }_{j} {\sum }_{a = 1}^{d} {c}_{j}^{( a )} {h}_{j}^{( a )} , \qquad ( 16 )$$

where {W^{(a)k}}, U^{(a)}, and h^{(a)} are, respectively, the connection weights between visible units and factors, the connection weights between hidden units and factors, and the interaction-modulating hidden units for order a. Please note that, when a=1, the energy term Σ_{f}(ΣᵢW_{if}^{(1)k})(ΣⱼU_{jf}⁽¹⁾hⱼ⁽¹⁾) is a factored version of traditional RBM. In fpsRBM, we can view {h^{(a)}} as a complete set of hidden representations gating different orders of feature interactions up to order d.

If we only use one set of hidden units h, connection weights u, and {w^{k}} for all the interaction terms with all possible orders from 1 to d, the above energy function is analogous to the following form,

$$- E ( v , h ) = {\sum }_{f} {( 1 + {\sum }_{ik} {W}_{if}^{k} {v}_{i}^{k} )}^{d} ( {\sum }_{j} {U}_{jf} {h}_{j} ) - {\sum }_{i} log {Z}_{i}^{′′′} + {\sum }_{ik} {b}_{i}^{k} {v}_{i}^{k} + {\sum }_{j} {c}_{j} {h}_{j} . \qquad ( 17 )$$

We call the semi-RBM defined by the above energy function “weight sharing factored polynomial semi-RBM” (ws-fpsRBM).

The inference in factored semi-RBMs is similar to that of IsRBM: the conditional distributions for hidden units are conditionally independent given the visibles, but the conditional distributions for visible units given the hiddens are dependent, so we need to use “mean-field” updates to get the approximate samples for the visibles.

The conditionals and the mean-field updates for fpsRBM and ws-fpsRBM are as follows (the ones for fsRBM is almost the same as those for ws-fpsRBM due to the high similarity in their energy functions),

$$\begin{matrix} p ( {h}_{j}^{( a )} \vert v ) = sigmoid ( {\sum }_{f} {{U}_{jf}^{( a )} ( {\sum }_{ik} {W}_{if}^{( a ) k} {v}_{i}^{k} )}^{a} + {c}_{j}^{( a )} ) , & ( 18 ) \\ {r}^{t} ( {v}_{i}^{k} ) = λ {r}^{t - 1} ( {v}_{i}^{k} ) + ( 1 - λ ) \times & \\ soft max ( {\sum }_{f} {\sum }_{a = 1}^{d} ( {\sum }_{i} {( {W}_{if}^{( a ) k} {r}^{t - 1} ( {v}_{i}^{k} ) )}^{a} ( {\sum }_{j} {U}_{jf}^{( a )} {h}_{j}^{( a )} ) + {b}_{i}^{k} ) , k ) , & \\ t = 1 , … , T , 0 < λ < 1 , for fpsRBM , & \\ p ( {h}_{j} \vert v ) = sigmoid ( {\sum }_{f} {{U}_{jf} ( 1 + {\sum }_{ik} {W}_{if}^{k} {v}_{i}^{k} )}^{d} + {c}_{j} ) , & ( 19 ) \\ {r}^{t} ( {v}_{i}^{k} ) = λ {r}^{t - 1} ( {v}_{i}^{k} ) + ( 1 - λ ) \times & \\ soft max ( {\sum }_{f} ( {( 1 + {\sum }_{i} {W}_{if}^{k} {r}^{t - 1} ( {v}_{i}^{k} ) )}^{d} ( {\sum }_{j} {U}_{jf} {h}_{j} ) + {b}_{i}^{k} ) , k ) , & \\ t = 1 , … , T , 0 < λ < 1 , for ws \text{-} fpsRBM , & \end{matrix}$$

where r^{t}(vᵢ^{k}) is the approximate sample for feature i taking value k by the “damped mean-field” update at the t-th iteration, given the hidden configuration h; and T is the maximum number of iterations of the mean-field updates. We initialize r⁰ (v) to be a data vector here.

Taking a similar form to the updates in IsRBM, the updates of the connection weights and biases for fpsRBM and ws-fpsRBM by contrastive divergence are as follows,

$$\begin{matrix}Δ {W}_{if}^{( a ) k} = ɛ {〈 {a ( {\sum }_{if} {W}_{if}^{( a )} {v}_{i}^{k} )}^{a - 1} ( {\sum }_{j} {U}_{jf}^{( a )} {h}_{j}^{( a )} ) {v}_{i}^{k} 〉}_{data} - {〈 {a ( {\sum }_{if} {W}_{if}^{( a )} {r}^{T} ( {v}_{i}^{k} ) )}^{a - 1} ( {\sum }_{j} {U}_{jf}^{( a )} {h}_{j }^{( a )} ) {r}^{T} ( {v}_{i}^{k} ) 〉}_{recon} ) , \\ Δ {U}_{jf }^{( a )} = ɛ {〈 {( {\sum }_{if} {W}_{if}^{( a )} {v}_{i}^{k} )}^{a} {h}_{j}^{( a )} 〉}_{data} - {〈 {( {\sum }_{if} {W}_{if}^{( a )} {r}^{T} ( {v}_{i}^{k} ) )}^{a} {h}_{j}^{( a )} 〉}_{recon} , \\ Δ {c}_{j}^{( a )} = ɛ ( {〈 {h}_{j}^{( a )} 〉}_{data} - {〈 {h}_{j}^{( a )} 〉}_{recon} ) , \\ for fpsRBM , & ( 20 ) \\ Δ {W}_{if}^{k} = ɛ {〈 {d ( 1 + {\sum }_{if} {W}_{if} {v}_{i}^{k} )}^{d - 1} ( {\sum }_{j} {U}_{jf} {h}_{j} ) 〉}_{data} - {〈 {d ( 1 + {\sum }_{if} {W}_{if} {r}^{T} ( {v}_{i}^{k} ) )}^{d - 1} ( {\sum }_{j} {U}_{jf} {h}_{j} ) 〉}_{recon} ) , \\ Δ {U}_{jf} = ɛ {〈 {( 1 + {\sum }_{if} {W}_{if} {v}_{i}^{k} )}^{d} {h}_{j} 〉}_{data} - {〈 {( 1 + {\sum }_{if} {W}_{if} {r}^{T} ( {v}_{i}^{k} ) )}^{d} {h}_{j} 〉}_{recon} , \\ Δ {c}_{j} = ɛ ( {〈 {h}_{j} 〉}_{data} - {〈 {h}_{j} 〉}_{recon} ) , \\ for ws \text{-} fpsRBM , & ( 21 ) \\ Δ {b}_{i}^{k} = ɛ ( {〈 {v}_{i}^{k} 〉}_{data} - {〈 {r}^{T} ( {v}_{i}^{k} ) 〉}_{recon} ) , & ( 22 )\end{matrix}$$

where fpsRBM and ws-fpsRBM share the same update for the biases of the visible units. Comparing fpsRBM to ws-fpsRBM, we see that the former is more complex and flexible than the latter, and both models have more orders of explicit feature interactions than fsRBM.

Next we will discuss Semi-supervised semi-RBM and conditional distribution for visibles. The semi-RBMs for modeling discrete categorical data described in the previous section can be easily extended to a semi-supervised setting, and then we get semi-supervised semi-RBMs (s³ RBMs). To do that, we simply view the multi-class label of a data vector as an additional softmax visible input. For description convenience, we assume that the number of classes is equal to the number of possible discrete values taken by input features. Thereby, the energy functions of s³ RBMs will be almost the same as the energy functions of semi-RBMs described in the previous section, except that we call one of the visible units (for example, the i-th one) {y^{k}} instead of {vᵢ^{k}}. And y^{k}=1 if and only if the class label of an input data vector is k.

For unlabeled data, we treat {y^{k}} as missing values, and we train a separate semi-RBM without the class unit y, which shares all the other weights and biases with the semi-RBM containing visible unit y.

In s³RBM, given an input vector, we can easily predict its class label. The conditional distributions of p(y|v) for IsRBM, fpsRBM, and ws-fpsRBM have the following respective forms,

$$\begin{matrix}p ( {y}^{k} = 1 \vert v ) = soft max ( \begin{matrix}{b}_{y}^{k} + {\sum }_{{i}^{′} {k}^{′}} {L}_{{yi}^{′} {kk}^{′}} {v}_{{i}^{′}}^{{k}^{′}} + \\ {\sum }_{j} log ( 1 + exp ( \begin{matrix}{\sum }_{{i}^{′} {k}^{′}} {w}_{{i}^{′} j}^{{k}^{′}} {v}_{{i}^{′}}^{{k}^{′}} + \\ {w}_{yj}^{k} + {c}_{j}\end{matrix} ) ) , k\end{matrix} ) , & ( 23 ) \\ p ( {y}^{k} + 1 \vert v ) = soft max ( {b}_{y}^{k} + {\sum }_{j} log ( 1 + exp ( \begin{matrix}{\sum }_{f} {\sum }_{a = 1}^{d} \\ {( \begin{matrix}{W}_{yf}^{( a ) k} + \\ {\sum }_{{i}^{′} {k}^{′}} {W}_{{i}^{′} f}^{( a ) {k}^{′}} {v}_{{i}^{′}}^{{k}^{′}}\end{matrix} )}^{a} {U}_{jf}^{( a )} + {c}_{j}^{( a )}\end{matrix} ) ) , k ) , & ( 24 ) \\ p ( {y}^{k} = 1 \vert v ) = soft max ( {b}_{y}^{k} + {\sum }_{j} log ( 1 + exp ( {\sum }_{f} {( \begin{matrix}1 + {W}_{yf}^{k} + \\ {\sum }_{{i}^{′} {k}^{′}} {W}_{{i}^{′} f}^{{k}^{′}} {v}_{{i}^{′}}^{{k}^{′}}\end{matrix} )}^{d} {U}_{jf} + {c}_{j} ) ) , k ) , & ( 25 )\end{matrix}$$

where b_{y}^{k} is the biase term for y^{k}. Because y in the subscript indexes the special visible unit corresponding to the class label of v, we can use exactly the same equations above to calculate the conditional distributions p(vᵢ^{k}|v₋ᵢ) by simply replacing the subscript index y with i.

Although we can efficiently compute the conditionals p(y^{k}=1|v) and p(vᵢ^{k}|v₋ᵢ), we must sum an exponential number of configurations over v_{-(S∪V)} to compute p(v_{S}|v_{V}) for all the factored semi-RBMs with multiplicative interactions, where S and V denote two arbitrary subsets of visible units. We took a similar approach to the one in [?]. But unlike in RBM, we cannot compute p(h|v_{V}) analytically due to the interaction terms involving other visible units than in V. Instead, we approximate the conditional distribution over hiddens by treating other visible units v_{-(S∪V)} as missing values and ignoring them. Given the approximate conditional distribution over hiddens \hat{p}(h|v_{F}), we run the damped mean-field updates by clamping observed visibles on v_{V} at each iteration t, and we use the final output of the mean-field updates {r^{T}(vᵢ^{k})}_{i∈S}^{k∈{1 . . . k}} to approximate p(v_{S}|v_{V}).

For IsRBM, we can compute p(v_{S}|v_{V}) exactly as follows,

$$p ( {v}_{S} \vert {v}_{V} ) = {Π}_{ik : i ∈ S} soft max {( \begin{matrix}\begin{matrix}{b}_{i}^{k} + {\sum }_{{i}^{′} {k}^{′} : {i}^{′} ∈ S ⋃ V} {L}_{{ii}^{′} {kk}^{′}} {v}_{{i}^{′}}^{{k}^{′}} + \\ {\sum }_{j} log ( 1 + exp ( {\sum }_{{i}^{′} {k}^{′} : {i}^{′} ∈ S ⋃ V} {w}_{{i}^{′} j}^{{k}^{′}} {v}_{{i}^{′}}^{{k}^{′}} + {c}_{j} ) ) +\end{matrix} \\ {\sum }_{{i}^{″} ∉ ( S ⋃ V )} log ( {\sum }_{{k}^{″}} exp ( {L}_{{ii}^{″} {kk}^{″}} ) ) , k\end{matrix} )}^{[ {v}_{i}^{k} = 1 ]} {( \begin{matrix}\begin{matrix}{b}_{i}^{k} + {\sum }_{{i}^{′} {k}^{′} : {i}^{′} ∈ S ⋃ V} {L}_{{ii}^{′} {kk}^{′}} {v}_{{i}^{′}}^{{k}^{′}} + \\ {\sum }_{j} log ( 1 + exp ( {\sum }_{{i}^{′} {k}^{′} : {i}^{′} ∈ S ⋃ V} {w}_{{i}^{′} j}^{{k}^{′}} {v}_{{i}^{′}}^{{k}^{′}} + {c}_{j} ) ) +\end{matrix} \\ {\sum }_{{i}^{″} ∉ ( S ⋃ V )} log ( {\sum }_{{k}^{″}} exp ( {L}_{{ii}^{″} {kk}^{″}} ) ) , k\end{matrix} )}^{[ {v}_{i}^{k} = 1 ]} , \qquad ( 26 )$$

where [·] is an indicator function. We must enumerate K^{size(S)} possible configurations to compute the conditional distributions above, but we can use a similar mean-field approximation strategy to the one for fsRBMs to approximate p(v_{S}|v_{V}) for IsRBM.

Next, one application of the system of FIGS. 2-3 is detailed. Chromatin Immunoprecipitation followed by parallel sequencing (ChIP-Seq) makes it possible to accurately identify Transcription Factor (TF) bindings and histone modifications at a genome-wide scale, which enables us to study the combinatorial interactions involving TF bindings and histone modifications. The semi-Restricted Boltzmann Machines is used to model the dependencies between discretized ChIP-Seq signals. Specifically, we predict a subset of ChIP-Seq signals given the others, and analyze the interaction strength among different ChIP-Seq signals. We extend previous Semi-Restricted Boltzmann Machines to have higher-order lateral connections between softmax visible units (features) to model feature dependencies. In the energy functions of our models, lateral connections are enforced either explictly by interaction terms between pairwise features or implicitly by factored high-order multiplicative polynomial terms between features. We also extend our models to a deep learning setting to embed the discretized ChIP-Seq signals into a low-dimensional space for data visualization and gene function analysis. Our experimental results on the ChIP-Seq dataset from the ENCODE project demonstrate the powerful capabilities of our models in determining biologically interesting dependencies among transcription factor bindings and histone modifications and the advantages of our models over simpler ones. To further show that our model is general, we also achieved high good performance of our model for denoising USPS handwritten digit data.

To train the deep gated high-order neural network for nonlinear semantic indexing in FIG. 3, we mainly use fpsRBM discussed above as the semi-RBM module for pre-training. For modeling system input feature interactions, we can use any type of semi-RBMs discussed, but fpsRBM and ws-fpsRBM are more powerful than others.s³ RBM can be used for classification in a semi-supervised learning setting.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method for determining complex interactions among system inputs, comprising:
using semi-Restricted Boltzmann Machines (RBMs) with factorized gated interactions of different orders to model complex interactions among system inputs,
applying semi-RBMs to train a deep neural network with high-order within-layer interactions for learning a distance metric and a feature mapping; and
tuning the deep neural network by minimizing margin violations between positive query document pairs and corresponding negative pairs.

2. The method of claim 1, comprising identifying complex nonlinear system input interactions for data denoising and data visualization.

3. The method of claim 1, wherein the semi-RBMs have gated interactions with a combination of orders ranging from 1 to m to approximate an arbitrary-order combinatorial input feature interactions in words and in Transcription Factors (TFs).

4. The method of claim 1, wherein hidden units of the semi-RBMs act as binary switches controlling interactions between input features.

5. The method of claim 1, comprising using factorization to reduce the number of parameters. The method of claim 1, comprising sampling from the semi-RBMs by using either fast deterministic damped mean-field updates or prolonged Gibbs sampling.

6. The method of claim 1, wherein parameters of semi-RBMs are learned using Contrastive Divergence.

7. The method of claim 1, wherein after a semi-RBM is learned, comprising treating inferred hidden activities of input data as new data to learn another semi-RBM and forming a deep belief net with gated high order interactions.

8. The method of claim 1, wherein with pairs of discrete representations of a query and a document, using semi-RBMs with gated arbitrary-order interactions to pre-train a deep neural network and generating a similarity score between a query and a document, in which a penultimate layer corresponds to a non-linear feature embedding of the original system input features.

9. The method of claim 8, further comprising using back-propagation to fine-tune parameters of the deep gated high-order neural network to make positive pairs of query, wherein document always have larger similarity scores than negative pairs based on margin maximization.

10. The method of claim 1, comprising modeling complex interactions between different words in documents and queries and predicting the bindings of TFs given some other TFs for understanding deep semantic information for information retrieval and TF binding redundancy and TF interactions for gene regulation.

11. The method of claim 1, comprising applying high-order semi-RBMs for modeling feature interactions including word interactions in documents or protein interactions in biology.

12. The method of claim 1, wherein the deep neural network has multiple layers.

13. The method of claim 1, comprising providing a given discretized query and document representation as input to a non-linear SSI system, and applying the semi-RBMs to pre-train the SSI system.

14. The method of claim 13, comprising fine-tuning the non-linear SSI system using back-propagation to minimize a margin-based rank loss.

15. The method of claim 13, wherein the discrete document representation includes a Bag of Word representation or a discretized term frequency—inverse document frequency(TF-IDF) representation.

16. The method of claim 1, comprising training by minimizing a margin ranking loss on a tuple (q, d⁺, d⁻):
$${\sum }_{( q , {d}^{+} , {d}^{-} )} max ( 0 , 1 - f ( q , {d}^{+} ) + f ( q , {d}^{-} ) ) ,$$
where q is the query, d⁺ is a relevant document, and d⁻ is an irrelevant document, f(·,·) is a similarity score.
